(19) United States
(12) Patent Application Publication
(10) Pub. No.: US 2008/0193870 A1
(43) Pub. Date: Aug. 14, 2008

(54) Toner Particles and Method and System for the Production Thereof

(76) Inventors: Hans Paffhausen, Ottikon (CH); Ulrich Morf, Egg (CH); Joachim Kretschmer, Ruti (CH)

Correspondence Address: FAY SHARPE LLP, 1100 SUPERIOR AVENUE, SEVENTH FLOOR, CLEVELAND, OH, 44114, US

(21) Appl. No.: 10/587,959

(22) PCT Filed: Jan. 28, 2005
(86) PCT No.: PCT/EP05/00857

§ 371 Date: Apr. 4, 2007

(30) Foreign Application Priority Data
Jan. 29, 2004 (DE) 10 2004 004 554.2
Dec. 15, 2004 (CH) 02078/04

(51) Int. Cl. G03G 9/087; B01J 19/12; B01J 19/00

(52) U.S. Cl. 430/109.3; 430/137.15; 422/186; 422/186.3; 422/131

(57) ABSTRACT

The invention relates to a toner powder wherein the individual toner particles of the toner powder contain colorants incorporated into at least one polymer, in particular, pigments. The initial product of the polymer consists of a liquid phase based on a monomer and/or oligomer. Subsequently, the colorants, in particular pigments, are dispersed in said liquid phase. Fine drops having a predetermined drop size are produced from the dispersion. A polymerization reaction of the monomers and/or the oligomers in order to form the polymer is then provoked in the individual drops by exposing the drops to electromagnetic waves or electrons, whereby the polymerized drops form the toner particles of the toner powder. The invention also relates to a system for the production of toner powder in addition to toner powder itself. In an another embodiment, the invention relates to a method for the production of toner powder, wherein the individual toner particles thereof comprise at least one colorant incorporated into at least one polymer and said method comprises the following steps: The initial product of the polymer consists of a liquid phase based on at least one monomer and/or oligomer; the at least one colorant is dispersed in said liquid phase and the dispersion is applied to a surface and is hardened thereon by means of polymerization of the monomers and/or oligomers. Subsequently, the product obtained according to said method is removed from the surface and communited, in particular, ground. The invention enables the desired toner particle size of toner powder to be adjusted in a precise manner with a minimum amount of technical and economical expenditure.

The invention relates to the area of laser print and copying technology. It relates particularly to toner particles and a method and a system for the production thereof according to the superimposed concept of the independent patent claims. Toners have been known for a long time in various technical copying fields. They are used, for example, in traditional copying methods (cylinder transfer) or are employed with laser printers. The toner is provided in the form of toner powder, which consists of minute toner particles, which traditionally present a particle size of 5 to 10 μm.

Furthermore, toner particles are supposed to have good melting properties, minimal fixing temperature and low gloss, good mechanical properties in regard to ability of being made into powder, low tendency to the so-called ‘housing stability’, sufficient stability on paper as well as good pigment compatibility.

The individual toner particles are essentially formed as follows: in addition to the colorant or colorants, in particular a pigment or pigments, mostly one or several additional substances are incorporated in the polymer materials: this involves, for example, resins, load control agents, surface-active additives as well as additional property-controlling substances. Typical materials, which serve as binding material matrix in the individual toner particles originate from monomers or oligomers, which form, by means of polymerization, a polymer matrix, into which the colorants are incorporated. Traditionally, the formed polymers have a glass transition temperature of approximately 50 to 70° C. For the production of the polymer matrix, monomers and/or oligomers are used which are in particular based on styrene, acrylates, methacrylates and/or butadiene. In individual cases it is also of benefit to use the starter monomers or starter oligomers of polyesters. The polymer materials serve as carrier substances for the pigments and the additional agents and provide the individual toner particles with a comparative defined form and size.

By way of additional substances, waxes can be incorporated into the toner particles, which is understood to be a material that is kneadable at 20° C., which is solid to fragile, hard, coarse to fine-crystalline, transparent to opaque, but not glass-like and which, as a rule, converts at approximately 50 to 90° C., in exceptional cases also up to approximately 200° C., into a meltable, low-viscous state without decomposition and which is already slightly above the melting point relatively low-viscous and not stringy.

Instead of waxes, such substances may also be used which possess appropriate physical properties or which are “wax-similar”. The addition of waxes, which can replace silicon oil, is to facilitate, for example, the release of toner particles from the print cylinder in the conventional copying methods. During melting, waxes have a clearly lower temperature than the polymers forming the matrix of the toner particles. They also present a different temperature-viscosity ratio.

The load control substances serve for adjustment of the required load level in the individual toner particles. This makes it possible to attract the individual toner particles in targeted fashion during the printing or copying process from the respective printing equipment, such as the print cylinder. Such load control substances have a predetermined load capacity, so that according to the added amount, the toner particles are precisely charged or are attracted by a load carrier, for example a printing cylinder with variably charged surface in accordance with the picture to be printed. By way of load control substances, iron oxides are employed, for example.

The surface-active additives are to provide the surface of the toner particles with the desired physical properties, in particular enhance the toner flow and the adhesion when used in copying and printing equipment. This involves in particular silicic acids, titanium dioxide compounds as well as organo-metallic salts. Pyrogenic silicic acids, which are of particular benefit, generally have an average particle size of approximately 7 to 40 nm (300 to 50 m²/g surface according to BET), good initial flow and low adhesion properties.

Pigments are preferably employed as colorants. In this context, pigments are understood to be colorants which are insoluble in aqueous media. Instead of pigments or in addition to pigments, soluble colorants can be used. The pigments contained in the toner particles preferably have a diameter of approximately 0.015 to 0.5 μm.

In addition, in case of individual toners, the toner particles can contain magnetic materials, such as magnetite, for example. There are application cases where the magnetic material is not directly contained in the toner particles, but where the toner particles when used are mixed with powdery magnetic material (two component toner), as well as toners which can function without iron oxide (one component toner).

Toners are produced according to different and in part relatively expensive methods:

With respect to the most widely used method, the colorant, in particular a pigment, such as carbon black, for example, is extruded in an extruder to form a strand together with load control substances, wax or a wax-similar materials and with a magnetic material, for example, magnetite, with polymer materials at increased temperature. This material is then cooled. After that, it is expensively comminuted in a grinding process. Then follows aerodynamic sorting with a view toward the desirable particle size. After that, the toner particles are generally subjected to further surface treatment in order to adjust the desired properties.

Of disadvantage for the described method is firstly the large expenditure of energy which is required for the extrusion and grinding and, secondly, that precise adjustment of toner particle size is not possible. Instead, toner particles are produced with widely scattered particle size distribution, so that the produced toner particles must be subjected to expensive sorting after their manufacture.

Due to the imprecise adjustment possibilities in regard to the toner particle size, the portion of toner particles which are rejected or eliminated by sorting based on particle diameter which is either too small or too large and thus unsuitable for further utilization, is comparatively large, so that the quantity of reject toner is high. The reject material is either returned to the manufacturing process or expensively disposed of by way of special trash.

Another drawback with the known method, in which toner particles are produced from an extruded basic mass by means of comminution and grinding consists in that the toner particles on the one hand have a rough surface and therefore tend to bake together. On the other hand, particularly during comminution and grinding of the basic mass, extremely fine dust is produced, which must be removed by means of expensive filtration in order to avoid health impairments of the employees and also to prevent dust explosions, so that the traditionally in large industrial scale performed manufacture of the toners is very expensive and cost-intensive.

It is thus the object of the invention to specify a method and a system for the production of toner powder and also a corresponding toner powder, relative to which the above named drawbacks do not occur. In addition, precise adjustment of the toner particle size is to be facilitated with comparatively low technical and economic expenditure.

The hereinafter described invention presents itself in two variations, and to each of which being attributable a method, a system for its implementation as well as the toner particles obtainable from same. In the following, a description is first given of “Variation A” and then of “Variation B”. These variations have one bridging communality. According to a beneficial embodiment of variation A, droplets, partially hardened toner particles or the solid toner particles are directed to a moving conveyor belt, on which the polymerization reaction takes place, is continued and/or concluded. “Variation B” picks up this idea in abstracted form.

In regard to Variation A according to the invention: The above object is solved by a method according to variation A for the production of toner powder, wherein the individual toner particles of the toner powder contain colorants incorporated into at least one polymer, in particular pigments and which is characterized in that as starter material for the polymer a liquid phase based on a monomer and/or an oligomer is provided, the colorants are dispersed in said liquid phase, from the dispersion are produced extremely fine droplets, in particular having a predetermined drop size, and that by radiation of the droplets with electromagnetic waves or electrons there is caused in the individual droplets an especially defined polymerization reaction of the monomers and/or oligomers for the formation of the polymer, whereby the polymerized droplets form the toner particles of the toner powder. Furthermore, the above object is solved by toner powder with toner particles, obtainable according to the above described method.

Finally, a solution component of the above object is also a system for the production of toner powder wherein the individual toner particles of the toner powder contain pigments incorporated in at least one polymer, whereby said system is characterized by a supply container for a dispersion of colorants, in particular pigments in a liquid phase based on monomers and/or oligomers which serve as starter substances for the polymer of the toner particles, a droplet generator connected with the supply container, with a multitude of jets for generating extremely fine dispersion droplets with particularly defined droplet size and a radiation device for irradiating the dispersion droplets created by the droplet generator with electromagnetic waves or electrons.

If one speaks of polymerization within the scope of the invention, then said term is to be understood in its wider sense in view of the actual technological situation on which the present invention is based. In the abstract, polymerization involves the superimposed concept for the somehow undertaken transformation of low-molecular compounds, namely monomers and/or oligomers into high-molecular compounds, i.e. polymers, macro-molecules or polymerisates. Polymerization may thus also mean a “poly-reaction” with the sub-concepts of poly-addition and poly-condensation. In this context, the term polymerisate is used for poly-adducts (poly-addition products) or poly-condensates. The addition reactions take place without split-off of low-molecular compounds, frequently with displacement of hydrogen atoms. Among the poly-addition products are in particular such makes which go back to monomers and/or oligomers with unsaturated compounds, in particular double bond. This involves, for example monomers and/or oligomers on acrylate base, methacrylate base, styrene base and/or butadiene base.

There are, however, also additions reactions where such double bonds do not exist, but where cyclical starter monomers within the scope of a ring opening broaden into an oligomer and later into a polymer. As example one can name here polyurethanes. The poly-condensation products, preferred less than “polymers” within the scope of the invention go back to a poly-reaction in which condensations take place between bi- or higher functional monomers. Important polymers among these are polyamides, polyimides, polyesters, polycarbonates, aminoplasts and phenoplasts. The low-molecular compounds formed and precipitated by the poly-condensation must, however, be easily removable. In most instances this involves water. Therefore, the temperature at which the hot droplets are generated must be relatively high and must also remain at a comparatively high temperature in order to remove the water.

Within the scope of the invention, it is possible, as has been indicated, to not only make use of polymerisates but also oligomers. One understands under oligomers compounds within the molecule of which only a few atoms or atom-groups (constitutional units) of the same type or a different type are repeatedly linked and whose physical properties clearly change with a change in the molecule size as a result of adding or removal or one or several constitutional units. Oligomers are obtained in targeted fashion either by poly-reactions (oligo-polymerization) of a monomer or mixtures of different monomers or by decomposition of polymers.

If oligomers are already employed for the generation of the droplets within the scope of the invention, then attention needs to be paid that (with increased temperature) the polymerization degree will not be too high. Too high a polymerization degree leads to a situation that excessive viscosity sets in within the generated droplets, which has a detrimental influence upon the droplet size and thus also on the size of the toner particles and also their shape. Too high a viscosity occasionally leads to the result that the toner particles do not present the desirable spherical shape.

One essential idea on which the invention is based is the formation of a polymer-matrix, whereby the starter monomers or starter oligomers are present in the liquid phase or as liquid phase before polymerization, so that the colorants, in particular pigments, as well as perhaps additional additives, such as load control substances, can, on the one hand, be uniformly mixed with the monomers or oligomers, while, on the other hand, the viscosity of the liquid phase can be adjusted in such manner that from the developing dispersion by means of suitable methods, such as the ink-jet method or the bubble-jet method, droplets can be produced with defined droplet size. In this case it has been proven as particularly beneficial, if to the addressed liquid color there is added for control of viscosity or for optimizing of process procedures, a volatile liquid, in particular an easily volatile liquid.

The percentage of said easily volatile solvent lies preferably at less than 15% by weight, in particular less than 10% by weight. In this case inert fluids are preferably involved, which do not have a negative influence upon the desired chemical reactions. These solvents are capable of dissolving, at least in part, the monomer and/or oligomer starter materials and also the already developed polymer.

The solvent is at least partially evaporated during hardening, which results in accelerated polymerization. Evaporation takes preferably place under supply of energy, in particular thermal energy, but can occur by itself or be accelerated by negative pressure or a ventilator. A solvent moreover enhances thorough mixing of the monomers and/or oligomers with the colorant or colorants and the additives, so that selection of starter materials is less critical and thorough mixing can take place more rapidly and more cost-effectively. It is of particular benefit if one employs as easily volatile solvent a mixture of water and a low-boiling alcohol, such as in particular isopropyl alcohol and/or isobutanol. Suitable, however, are for example also ketones, in particular acetone and methylethyl-ketone. The boiling point of these perhaps additionally employed inert solvents lies preferably below 125° C., in particular below 100° C.

Another essential idea of the invention is based on causing a targeted and defined polymerization reaction of the monomers and/or the oligomers in the dispersion by means of radiation with electromagnetic waves such as UV rays or electrons. This makes it possible that, on the one hand, the monomers and/or the oligomers during the mixing with the colorants, in particular the pigments and the additives, do not yet start or if at all, start only to a minor degree, with lattice-like polymerization among each other, while, on the other hand directly following droplet formation, defined polymerization reactions are triggered between the monomers or oligomers in the respective droplet, triggered by the radiation.

In order to achieve particularly beneficial results, it makes sense, depending upon the type of the respectively selected monomers and oligomers, to adjust the dose of the electromagnetic waves accordingly. It has been shown that the dose of the UV-rays lies preferably in the range of 0.5 to 3.5 J/cm2, in particular in the range of 1.0 to 2.0 J/cm2.

With an electron ray treatment the dose lies preferably in the range of 5 to 500 kJ/m2, in particular in the range of 10 to 300 kJ/m2. In general, it is of benefit to first undertake the radiation with UV rays and to only undertake at the completion of the reaction, an electron treatment via electron radiation for further and concluding hardening in order to transform the polymeric matrix into its largely duroplastic or high-temperature thermo-plastic state. In most cases it suffices if the polymerization is initiated and continued by the discussed radiation with electromagnetic waves. Nevertheless, it has been shown in some cases that the incorporation of initiators will enhance the course of the polymerization.

Initiators are connected with the polymerization according to the meaning of the invention so as to start (initiate) the chemical reaction, and to be consumed during the initiation step, in part under installation of the initiators (fragments) into the developing compounds. They find broad application in polymerization reactions.

In this case, as a result of chemical, thermal or photo-chemical reaction, an active species is created from the initiator, said species reacting with a monomer molecule to a product to which are attached a large number of additional monomer molecules. Among the initiators are, for example, azo-compounds, peroxides, hydro-peroxides and peresters, also so-called redox-initiators, systems of oxidizing and reducing components, for example hydrogen-peroxide/iron (II iones) during the reaction of which radicals are produced. Since many monomers can spontaneously polymerize even without initiator addition, for example also via treatment with electro-magnetic waves, so that in these instances the initiators will only act in an accelerating fashion, they are also frequently identified as accelerators.

In order to be able to adapt the properties of the toner powder to the respective application purpose, it is of benefit to start the individual toner particles with appropriate additives, such as load control agents, interlink auxiliaries, chain transfer agents on the basis of monomers and/or oligomers, so that same are incorporated into the polymerized toner particles. It is also possible to apply some of these additives, after hardening of the toner particles, on the surface of the toner particles, for example by mixing or spraying.

Moreover, additional colorants can be added to the dispersion of monomers and/or oligomers and also pigments, in order to increase the gloss of the toner particles, which are likewise incorporated into the polymeric matrix of the toner particles.

Relative to the employed colorants, in particular pigments, the present invention is not subject to any relevant restriction. Furthermore, coloring agents may also be utilized.

The colorants may involve organic pigments and/or inorganic pigments. Suitable as inorganic pigments are, for example, titanium dioxides, zinc-sulfides, iron-oxides, chromium-oxides, nickel or chromium-antimony-titanium-oxides, cobalt-oxides and bismuth-vanadates. In some cases it is possible to beneficially use coloring agents alone without incorporation of pigments. The coloring agents which may be employed can serve for precision adjustment in regard to desired color shades. In principle, a distinction is made with respect to color pigments between the inorganic color pigments, the organic color pigments and the effect pigments.

From among the organic color pigments, preferable use is made in case of magenta pigments, of Ca-laked Azo, quinacridone, in case of cyanine-pigments phthalocyanine and in case of the yellow pigments, diarylide, mono-azo and isoindoline, benzimidazolon and azo-condensation product as well as napthol-red. Organic color pigments can also be classified according to the principal categories as follows: azo-pigments, poly-zydic pigments as well as pigments on phthalocyanine basis. With respect to coloring agents, a distinction can also be made according to natural and synthetic coloring agents. Among the best known synthetic coloring agents are: phthalocyanine, triphenylmethane, anthraquinone (cyanine/blue), monoazo/disazo (magenta/red), tartrazine (yellow), xanthene, disazo/polyazo, azo/metal complexes (black) as well as carbon black.

The utilized colorants, in particular pigments, shall be as finely particled as possible, with preference given to 95% and in particular 99% of the colorant particles having a particle size of equal to or smaller than 500 nm. The average particle size lies preferably at a value of less than 200 nm. Depending upon the respectively utilized colorants, in particular pigments, there can be a very strong distinction in the morphology of the colorants or pigment particles. In order to obtain a beneficial viscosity behavior of the discussed droplet dispersion, the particles should preferably have a spherical shape.

When compiling the starter materials for dispersion of very fine droplets which are generated within the scope of the invention-specific method and transferred into the toner particles, it is of benefit to place the viscosity within an optimal framework. The viscosity lies generally between 1 and 50 mPas, in particular between 5 and 30 mPas, depending upon the temperature which influences the extremely fine droplets within the range of action by the electro-magnetic waves. Said viscosity range favors multiple developments. If the viscosity is high, it means greater technical expenditure. On the other hand, maintenance of the viscosity framework means that the product of the method forms in beneficial form, such as for example the finished toner particles which have the desired size, shape and uniformity. The beneficial viscosity control can, as already addressed above, be undertaken by involvement of a low boiling liquid.

In the invention-specific manner it is achieved that from the dispersion prior to the polymerization droplets can be produced having high repetitive accuracy and defined droplet size, while a polymerization reaction of the monomers and oligomers is triggered by means of radiation in the generated droplets immediately following exit from a corresponding droplet generator, and the droplets are thus “frozen” in their droplet form, so that each hardened droplet forms a toner particle of the toner powder. By precise adjustment of the wave length and intensity of the electro-magnetic waves or of the electromagnetic density of the electrons, it is possible to achieve highly accurate adjustment of the degree of lattice-like polymerization of the monomers and/or oligomers during the polymerization reaction, as a result of which, the print result can be predetermined for subsequent utilization of the toner powder.

The toner particles which are produced in accordance with the invention distinguish themselves in particular by constant particle size. In addition, the hardened toner particles present an at least approximately uniform spherical shape, since the droplets prior to the polymerization reaction present at least approximate spherical shape due to the surface tension of the dispersion, and the droplets are frozen in said spherical shape by the externally provoked polymerization reaction, whereby a particularly smooth surface is formed on the finished toner particle.

The polymerization within the scope of the invention, under inclusion of all relevant parameters, such as for example radiation duration and radiation intensity, is controlled in such manner that preferably the average molecular weight number of the obtained polymerization product amounts to between 3000 to 500,000, while the average molecular weight value lies preferably between approximately 5,000 and 2,000,000.

Additional benefits of the invention or embodiments of the invention according to Variation A are apparent from the description which follows, the attributed sub-claims and the figures.

As has already been addressed earlier, the invention is specifically based on the idea of producing highly uniform extremely fine droplets with defined droplet size in a short period of time. One possibility to that effect consists in the utilization of a droplet generator, which presents for generating the dispersion droplets a multitude of jets, which are respectively assigned, according to the principle of the ink-jet print head, a thermo-electrical or piezo-electrical converter. Thus, with the piezo-ink-jet method the jet canal of the respective jet is contracted so strongly for a brief moment that a dispersion droplet is expelled from the jet. With respect to the bubble-ink-jet method, the dispersion contained in a jet canal assigned to the respective jet is heated to the extent that a gas bubble is formed in jolt-like fashion in the dispersion, which results in the expulsion of a dispersion droplet from the jet.

Such thermo-electrical or piezo-electrical converters, which are employed, for example, in ink-jet printers, distinguish themselves by extremely precise adjustment of droplet size with very high repetitive accuracy rate, so that it is possible, over a long period of time to expel extremely fine droplets of defined droplet size from the droplet generator. For adjustment of dispersion amount per to be generated droplet, these converters are contacted electrically in order to expel the droplets, while the dispersion is supplied to the jets from a dispersion reservoir.

It has been shown that a piezo-inkjet print head is particularly well suited as droplet generator, which is used, for example to produce large surface prints. The piezo-ink-jet print head is firmly installed to that end in a holding device, connected with a dispersion reservoir and sprays the droplets onto a correspondingly provided receiving device, for example a conveyor belt. The droplet size of the expelled extremely fine droplets is preferably controlled by modulation of the energy supply of the converters. The droplet output of the droplet generator per second and jet ranges within 1000 to 50 000 Hz, so that a sufficient quantity of droplets can be generated.

By vertical expulsion of the liquid droplet from the jets, it is possible to extend, in targeted fashion, the flight path of the droplets, so that the droplets exist in a state of separation as long as possible and are uniformly surrounded by the atmosphere of the space in which they are expelled. This achieves at least an initial hardening and solidification of the toner particle developing from the droplets, prior to their collection after expulsion. In order to further extend the flight duration of the droplets it is additionally suggested to expel the droplets into an electrical field in which they are kept, at least for a short period of time, in a state of suspension, provided they were previously charged electrically.

For triggering and positively influencing the polymerization reaction between the monomers and/or oligomers in the droplets, the droplets are preferably irradiated with UV rays or with electron rays. In particular, radiation of the droplets with UV rays has the advantage that by adjustment of a given wave length or of a given wave length range and also of the intensity of the UV rays, it is possible influence and to adjust in targeted fashion the polymerization reactions between the monomers and/or oligomers, so that a defined degree of interlinking in the polymer of the finished toner particle can be adapted to predetermined specifications during its manufacture and the individual toner particle adapted to its desired area of application. In order to prevent an agglomeration of the generated droplets, it is suggested in one variation of the invention-specific method that the expelled extremely fine droplets be charged electro-statically, so that they mutually repel each other due to their charges. The electro-static charge is preferably done by establishment of an electrical field at the exit aperture of the droplet generator, through which the droplets fly during expulsion.

Moreover, the droplets can also be directly charged electro-statically when they are produced. Should there occur any agglomerates, it is easy to destroy same by mechanical action, for example by means of simple grinding.

In a particularly preferred variation of the invention-specific method it is suggested to direct the droplets, the already partially solidified toner particles or the firm toner particles onto a preferably at high speed moving conveyor belt, on which they are distributed over a large area in order to carry out or complete the solidification process.

The solidified toner particles are subsequently swept away or brushed away from the conveyor belt and thereafter transported for further processing. In order to further accelerate and influence the polymerization process in the droplets and toner particles it is moreover suggested with this variation that the conveyor belt be heated or radiated by means of suitable devices, so that the droplets meet with a pre-heated conveyor belt. In addition, it is suggested that the conveyor belt be charged with opposite polarity in case of electrostatically charged toner particles or electrostatically charged droplets. The charging of the conveyor belt accomplishes that the expelled droplets are uniformly precipitated on the conveyor belt. By reversing the charge polarity of the conveyor belt or by passage of the conveyor belt past a more powerfully charged collector, for example a charged drum, it is, furthermore, possible separate the adhering toner particles from the conveyor belt after they have solidified and to transport them to be further processed.

Alternatively it is suggested to let the droplets during their flight, for example in free fall, harden to the extent that they get already at least partially polymerized into a receptor vessel or onto a conveyor belt. In addition, it is conceivable to keep electro-statically charged droplets in a state of suspension by establishing an electrical field in which the droplets are kept until such time as they are at least partially polymerized.

The droplet size of the extremely fine droplets which are expelled from the droplet generator is preferably adjusted in such fashion that the particle size of the obtained toner particles lies between approximately 2 and 9 μm, in particular between approximately 4 and 7 μm. As has been shown, it is possible as a result of the previously described precise adjustment of the droplet size to adjust the particle size of the finished toner particles in such manner that manufacture of toner powder is possible with toner particles where all toner particles have at least approximately the same particle size. Thus, it is not only possible to eliminate the previously necessary classification of toner particles in regard to the known methods. In addition, the reject amount of toner particles with particle size that is either too small or too large is about zero, as a result of which the invention-specific method provides a far-reaching economic benefit vis-à-vis the previously known methods.

Moreover, the energy use compared with the known methods, in particular with the highly energy-intensive previously described extrusion of polymer granulates and grinding of polymer granulates to toner particle is clearly lower with the invention-specific method, as a consequence of which its high economic efficiency provides another essential benefit, mainly in the large industrial scale manufacture of toner powder.

According to another aspect, the invention relates to a system according to Claim 20, for the manufacture of toner powder, where the individual toner particles of the toner powder are formed by pigments incorporated into at least one polymer. The invention-specific system presents to that effect a supply vessel for a dispersion of colorants, in particular pigments, in a liquid phase of monomers and/or oligomers, which serve as starter substances for the polymer of the toner particles, a droplet generator, connected with the supply vessel, with a multitude of jets to produce extremely fine dispersion droplets of largely defined droplet size, as well as a radiation device which serves for irradiating the dispersion droplets generated by the droplet generator with electromagnetic waves or electrons, preferably for radiation with UV light or electron rays.

In a particular specific embodiment of the invention-specific system, each jet of the droplet generator is assigned a piezo-electrical or a thermo-electrical converter, by means of which in one of the respective jet canals assigned to the jet there is generated a pressure impulse via contraction or by means of heating, through which a droplet of defined size is expelled from the jet.

For making contact with the converters, these are combined in groups in order to ensure uniform droplet formation, and connected with an electrical control. With the aid of the control, tension impulses are created for activation of the converters, as a result of which, via modification of the tension amplitude, the droplet size is definitely adjusted and by changing the impulse number per time unit, it is possible to predetermine the droplet number per time unit. The use of a traditional ink-jet print head has proven itself as particularly beneficial for the generation of droplets. Said ink-jet print heads distinguish themselves by very long service life and very high repetitive precision. Furthermore, it is possible to adjust the droplet size extremely accurately.

Moreover, it is of benefit to integrate into the system a mixing device for dispersing the pigments in the liquid phase on the basis of monomers and/or oligomers. Said mixing device can either be provided as separate unit in which the dispersion is mixed separately from the droplet generation. Or the mixing device is connected with the supply vessel of the droplet generator. In this case it is also conceivable that several supply vessels of several droplet generators are simultaneously supplied by a common mixing device.

In a particularly preferred specific embodiment of the invention-specific system, the droplets are sprayed onto a conveyor belt which preferably moves past the jets at high velocity. The utilization of a conveyor belt has the advantage that the polymerization of the monomers and/or the oligomers in the droplets can occur chronologically uncoupled from the expulsion from the jets, in that the droplets adhering to the conveyor belt are transported away from the site of the droplet generator. In regard to this specific embodiment of the invention-specific system it is of further benefit to arrange the radiation device along the transport path of the conveyor belt and to irradiate the dispersion droplet positioned on the conveyor belt with electromagnetic waves or electrons. In this manner, it is possible to adjust and predetermine the polymerization process in the individual droplets in particularly accurate fashion, so that the droplets which subsequently form the toner particles polymerize especially evenly and uniformly.

Alternatively, it is suggested that the radiation device be arranged directly behind the droplet generator, so that the dispersion droplets can already be irradiated upon exit from the droplet generator and stimulated to undergo polymerization. Instead of using a conveyor belt, it is also possible to expel the droplets in a closed radiation chamber into which the radiation device emits its rays. This is of benefit, for example, if the production process is to be closed off toward the exterior.

According to another aspect, the invention according to Claim 29 relates to toner powder with toner particles which were produced according to the invention-specific method.

In the following, the invention according to Variation A is described in detail making reference to the appended figures.

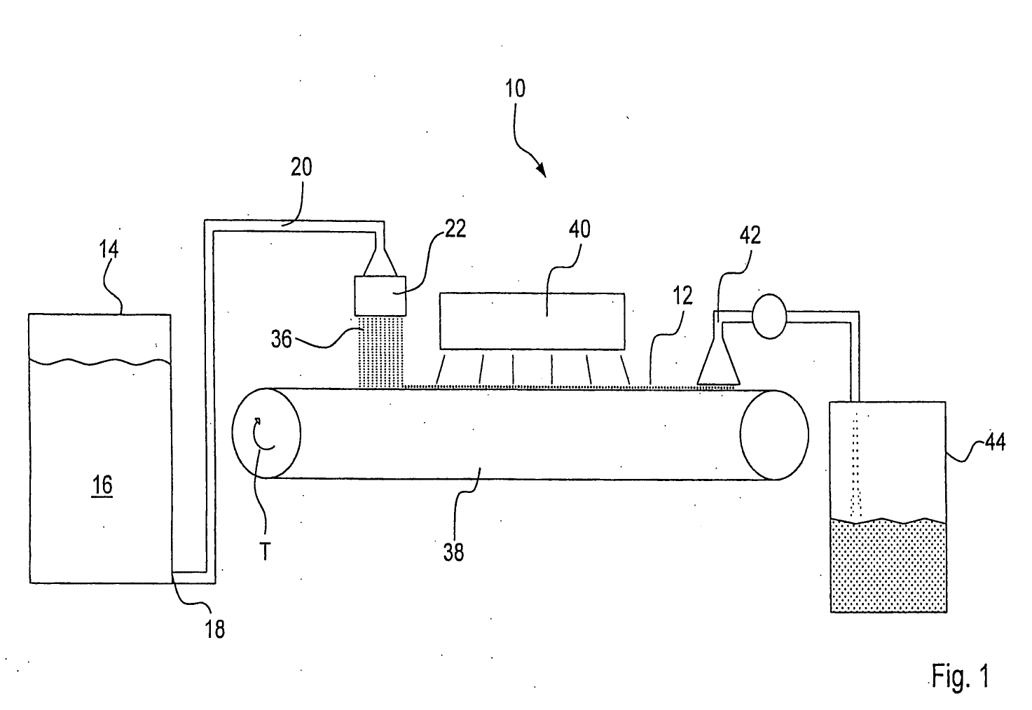

FIG. 1 shows a schematic representation of an invention-specific system for the manufacture of toner powder,

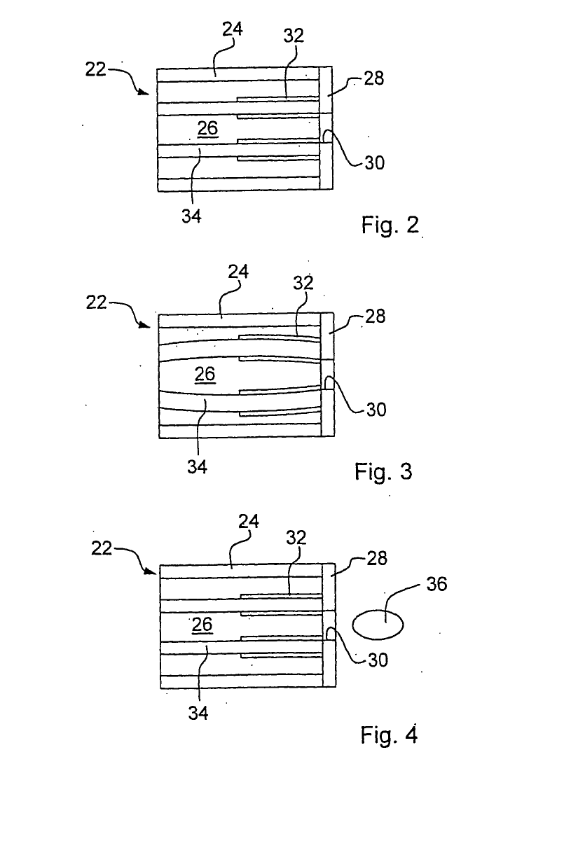

FIG. 2 shows a schematic sectional view through a jet body of an ink-jet print head utilized in the system,

FIG. 3 shows a schematic sectional view of the jet body immediately prior to the expulsion of the dispersion droplet, and

FIG. 4 shows a schematic sectional view of the jet body during expulsion of a dispersion droplet, and

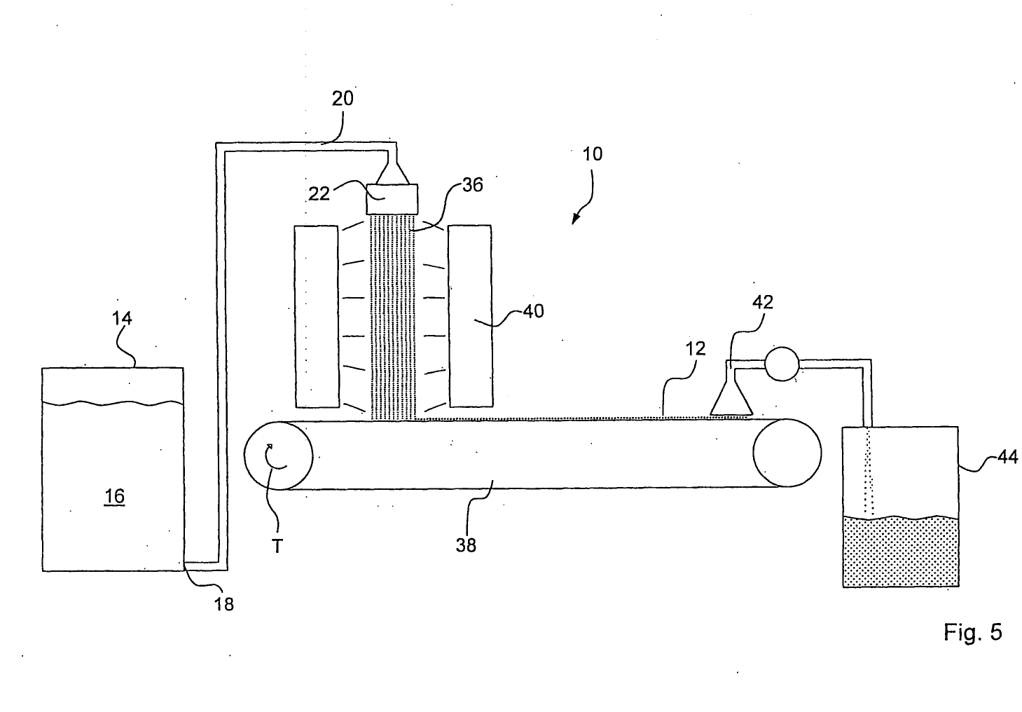

FIG. 5 shows a schematic representation of a modified embodiment of the in FIG. 1 represented invention-specific system for the manufacture of toner powder.

FIG. 1 depicts in schematic representation an invention-specific system 10 for the manufacture of toner powder. System 10 has a supply vessel 12, in which is contained a dispersion 16, which is formed from the starter substances for the individual toner particles 14, namely monomers and/or oligomers, in fluid phase, with pigments as well as perhaps additional color substances, surface-effective additives, load control substances and similar substances. In order to obtain highly uniform mixing of the developing dispersion 16, the monomers and/or oligomers, the pigments as well as the additional substances are mixed with each other by means of a mixing device which is not shown.

Near the bottom of the supply vessel 12 is provided an outlet 18, which is in communication via a transmission system 20 with an ink-jet print head 22 serving as droplet generator. The construction and operating mode of the ink-jet print head 22 is briefly explained in the following, making reference to FIG. 2 to 4.

As FIG. 2 to 4 indicate, the ink-jet print head 22 has a jet body 24 made of piezo material, in which are formed a multitude of parallel extending, next to each other, jet canals 26, which are in flow communication with the outlet 18 of the supply vessel 14 via a not represented distributor. At the front side of the jet body is attached a jet plate 28 in which jet apertures 30 are provided for every second jet canal 26. To each jet canal 26 are respectively assigned two four electrodes 32. The electrodes 32 are connected with a control which is not shown.

In a state of rest, as represented in FIG. 2, the jet canals 26 extend parallel to each other. If one puts the electrodes 32 of a jet canal 26 under tension, the tension causes a deformation of the walls 34 bordering the jet canal 26, as depicted in FIG. 3, which leads to a volume enlargement of the jet canal 26, so that a small amount of additional dispersion can flow from the outlet 20 into the jet canal 26. If the tension placed on the electrodes 32 is switched off, the walls 34 resume their original starter position as shown in FIG. 4, whereby the volume of the jet canal 26 is again reduced. A dispersion droplet 36 is hereby expelled from the open jet aperture 30. By appropriate adjustment and modulation of tension at the electrodes 32, for example by changing the tension amplitude of the tension impulses or the impulse number per time unit, it is possible in very simple and very precise manner to adjust and predetermine the droplet size of the dispersion droplet 36 as well as the number of dispersion droplets 36 to be generated.

As FIG. 1 further shows, the dispersion droplets 36 which exit from the ink-jet print head meet with a conveyor belt 38 moving at high velocity past the print head 22. The velocity of the conveyor belt 38 has been adjusted to the exiting volume of dispersion droplets, so that the droplets are positioned on the surface of the conveyor belt 38 in one area next to each other and behind each other.

Viewed in transport direction T of the conveyor belt 38, arranged behind the print head 22, is a radiation device provided, which irradiates the dispersion droplets 36 positioned on conveyor belt 38 with UV light having a predetermined, defined wave length range and a defined radiation intensity. As a result of irradiating the dispersion droplets 36 with UV light, a polymerization reaction is triggered between the monomers and/or oligomers in the dispersion droplets 36, whereby the polymerization degree of the hardened polymer can be adjusted by means of the adjusted wave length range and radiation intensity of the UV light. After polymerization, the hardened dispersion droplets 36 form the toner particles 12 of the toner powder. At the end of the conveyor belt 38 is arranged a collection device 42, which takes the individual toner particles 12 from the conveyor belt 38 and transfers same into a collection receptacle 44.

FIG. 5 depicts a modified embodiment of system 10 represented in FIG. 1, which only differs from the latter in that the radiation device 40 is arranged behind the ink-jet print head 22, so that the dispersion droplets 36 which exit from the ink-jet print head 22, are directly irradiated with UV light after being generated and begin already with the polymerization while in flight. The in flight polymerizing dispersion droplets 36 fall subsequently onto the conveyor belt 38 and are carried away by same from the ink-jet print head 22.

The represented system 10 and its modification constitute only one possible embodiment of the invention-specific system for the manufacture of toner powder. It is, for example, conceivable to employ instead of the described ink-jet print head 22, a so-called bubble-jet print head. In addition, it is within the scope of the invention to design the radiation device 40 for radiation of the conveyor belt 38 with electron rays. In this case, the radiation area would have to be encapsulated against the exterior. In addition, by means of static charge of the dispersion droplets during their generation and by establishing an electrical field in the area of the print head, it is possible to achieve a suspension of the dispersion droplets following exit from the print head, so that these can be irradiated in a state of suspense and begin their hardening.

In regard to Variation B according to the invention:

The above formulated object is also solved by means of a method or a system for the manufacture of toner powder of the initially mentioned kind with the characteristics of Patent Claims 30 and 37 as well as by toner particles according to Claim 40.

With the invention-specific method for manufacture of toner powder, whose individual toner particles contain at least one colorant, in particular at least one pigment, which is incorporated in at least one polymer, a liquid phase as starter material for the polymer is provided on the basis of a monomer and/or oligomer, at least the one colorant is dispersed in said liquid phase, the dispersion is applied to a surface, it is hardened thereon by means of polymerization and subsequently removed from the surface.

Beneficial embodiments of the invention-specific method according to Variation B are apparent from sub-claims 31 to 36 and of the invention-specific system according to Variation B from the sub-claims 38 to 39, to which reference is being made.

Additional substances which are perhaps needed for the manufacture of the toner powder, such as resins, load control agents, surface-active additives, waxes, magnetic materials and other property controlling agents are preferably mixed in with the liquid phase, preferably before the colorant is dispersed therein.

The term “dispersion” is to be interpreted in its broadest sense in the present context. This may involve a heterogeneous mixture between a solid or liquid colorant and the liquid phase. In general, however, the mixture will be homogeneous in which the colorant dissolves or disperses in the liquid phase.

Since the method starts out with a liquid phase, preferably at room temperature, wherein at least one colorant is dispersed, the energy- and machine-costly extrusion is eliminated, which is necessary with the traditional method according to the state of the art. Thus it is possible to manufacture toner powder particularly cost-effective.

In a preferred further development of the invention-specific method, the dispersion contains a solvent which is preferably capable of dissolving the developed polymer or acting as a solvent for the still present monomers and/or oligomers. The solvent is at least partially evaporated during hardening, which accelerates the polymerization. Evaporation occurs preferably under supply of energy, in particular thermal energy, but can also take place by itself or be accelerated by means of negative pressure or via a ventilator. A solvent promotes thorough mixing of the monomers and/or oligomers with the colorant or colorants and the additional substances, so that selection of starter substances is less critical and thorough mixing can be done more quickly and more cost-effectively. In order to avoid extensive repetitions, reference is made to the preceding elaborations regarding the use of solvents in connection with Variation A.

Within the present context, attention should be paid that the monomer and/or oligomer likewise presents beneficial solvent properties in order to facilitate and/or improve dispersion of colorant and/or additives. Under “solvent” one thus understands a solvent which is additionally added to the monomer and/or oligomer and which can be evaporated independently from the monomer and/or oligomer.

In a preferred further development of the invention-specific method, the dispersion is applied to the surface with an application thickness that corresponds at least approximately to the diameter of the toner particles to be produced. Preferably, consideration is to be paid whether the dispersion shrinks or expands during hardening, and, accordingly, one works with an application thickness which is either larger or smaller than the diameter of the toner particles to be produced. The dispersion is preferably applied, in essence, over the entire surface and is comminuted, preferably by means of grinding, after removal. The term ‘in essence, over the entire surface” is to be understood in the present context that a predominant portion of the surface, preferably more than 80% is covered by the dispersion. Full coverage, gap-free application however is not absolutely required.

Based on the application thickness, a flat intermediate product is formed following detachment from the surface, whose dimensions in one direction already correspond to those of the toner particles to be produced. Said flat intermediate product is comminuted in a further process step in order to obtain toner particles with the desired diameter. This is preferably done by means of grinding. Based on the already correct dimensions in one direction, comminution can take place with much less use of energy and much less wear and tear of equipment than would be the case with complete comminution involving a voluminous intermediate product, which occurs with a conventional method.

In a particularly preferred further development of the invention-specific method, the dispersion is applied onto the surface in the form of isolated droplets. An average droplet diameter is selected in this case in such manner that it corresponds at least approximately to the particle diameter of the toner particles to be produced. Attention is preferably also paid in this case as to whether the dispersion shrinks or expands and depending upon the situation, operates with an average droplet diameter which is larger or smaller than the diameter of the toner particle to be produced, so that, preferably toner particles of the desired size are formed after hardening. With this operating mode, the necessity of the grinding process is totally eliminated so that the toner powder can be produced in particularly efficient and cost-effective fashion.

In order to produce highly uniform and extremely fine droplets with defined droplet size in a short period of time, it is of particular benefit to utilize a droplet generator which presents a multitude of jets for generating the dispersion droplets, with each jet being assigned a piezo-electrical or thermo-electrical converter according to the principle of the ink-jet print head. With the piezo ink-jet method, the respective jet is so forcefully contracted with the aid of the piezo-electrical converter that a dispersion droplet is expelled from the jet. With the so-called bubble-ink-jet method, the dispersion that is contained in the jet canal assigned to the respective jet is heated to a degree that a gas bubble develops in jolt-like fashion in the dispersion, resulting in expulsion of a dispersion droplet from the jet.

Such thermo-electrical or piezo-electrical converters, which find application, for example, in ink-jet printers, distinguish themselves by extremely precise adjustment of droplet size having very high repetitive accuracy, so that extremely fine droplets of defined droplet size can be expelled over a long period of time from the droplet generator. For adjustment of dispersion volume per to be produced droplet, these converters are controlled electrically for expulsion of droplets, while the dispersion of the jets is supplied from a dispersion reservoir. In order to avoid extensive repetitions, reference is made to the preceding elaborations regarding the thermo-electrical or piezo-electrical converters in connection with the description of Variation A.

It has been shown that a piezo ink-jet print head is particularly well suited as droplet generator, which, for example, is employed for producing large-scale prints. The piezo ink-jet print head is firmly installed in a holding device for that purpose, it is connected with a dispersion reservoir and sprays the droplets onto a surface, for example the surface of a conveyor belt. Droplet size of the expelled extremely fine droplets is preferably controlled at the converter by electrical tension cycle. The expulsion of the droplets by the droplet generator per second and per jet lies in the range from 1 000 to 50 000 Hz, in order to produce a sufficient amount of droplets.

In order to prevent an agglomeration of the produced droplets, it is suggested in one variation of the method that the expelled extremely fine droplets be charged electrostatically, so that they mutually repel each other by their charges. The electro-static charge is preferably undertaken by establishment of an electrical field at the outlet aperture of the droplet generator through which the droplets fly during expulsion. Also, it is possible to electro-statically charge the droplets directly when they are being produced. Here again, reference is made to the preceding elaborations in regard to Variation A.

In addition, it is suggested in case of electrostatically charged toner particles or electrostatically charged droplets, that the surface be subjected to reverse polarity. Charging the conveyor belt has the result that the expelled droplets are uniformly precipitated on the surface. By reversing the charge polarity of the surface or by passage of the surface past a higher charged collection unit, for example a charged drum, it is, moreover, possible to detach the toner particles adhering to the surface after hardening and to transport them to be processed further.

The droplet size of the extremely fine droplets expelled from the droplet generator is adjusted in such manner that the particle size of the obtained toner particles lies between 2 and 9 μm, in particular between 4 and 7 μm. As has been shown, it is possible by means of the earlier described precise adjustment of droplet size, to adjust the particle size of the finished toner particles in such manner that manufacture of toner powder and toner particles is possible wherein almost all toner particles present at least the approximately same particle size. This not only eliminates the previously needed sorting of toner particles according to the known methods. In addition, the reject amount of toner particles having a size which is either too large or too small is close to zero, as a result of which the invention-specific manufacturing method offers a far-reaching economic benefit vis-à-vis the previously known methods. Furthermore, the use of energy, compared with the known methods, in particular the highly energy-intensive, previously described extrusion of polymer granulates and the grinding of the polymer granulates to toner particles, is clearly lower with the invention-specific method, and that, in turn, based on its economic efficiency, offers another essential benefit, mainly in regard to large-scale industrial manufacture of toner powders.

Another essential idea of the invention according to Variation B is based on the concept of effecting a targeted and defined polymerization reaction of the monomers and/or oligomers in the dispersion applied on the surface by the supply of energy, preferably by means of radiation with electromagnetic waves, such as UV rays, or electrons. By appropriate choice of monomers and/or oligomers one can achieve that these, on the one hand, will not yet begin or begin only to a minor extent with the polymerization process during the mixing with the pigments and the added substances, while, on the other hand, immediately after application of the dispersion onto the surface defined polymerization reactions are triggered between monomers or oligomers, caused by the radiation.

In connection with UV ray radiation, monomers and/or oligomers are particularly well suited which are used in known UV-hardening varnishes.

The method according to Variation B relative to the essential properties largely agrees with the invention according to Variation A. In order to avoid here inappropriate repetition concerning the essential common values, which can be readily recognized by a person skilled in the art, reference is made to the preceding representations relative to Variation A, in particular to the totality of elaborations in regard to droplet size of the extremely fine droplets, to polymerization including all detailed specifics, to the additives in polymerization, such as load control agents and similar, to the type of colorant in form of color agents and pigments, to all details of the employed dispersion, to adjustment of suitable viscosity, to the benefits which are provided by the operating mode according to Variation A, such as for example the repetitive accuracy, to the type of radiation, including the specific elaborations concerning radiation intensity, to the molecular weights of the obtained polymerisate, wherein all details of the respective section in which the discussed feature is being explained shall apply equally according to expert understanding. In other words, only those characteristics and measures, which were previously described in connection with Variation A, shall have no application for variation B if they obviously deviate from the core concepts of A.

Finally, a component for solving the above object is a system for the manufacture of toner powders, wherein the individual toner particles of the toner powder contain colorants incorporated into at least one polymer, in particular pigments, with said system being characterized by a supply vessel for a dispersion of colorants in a fluid phase based on monomers and/or oligomers, which serve as starter substances for the polymer of the toner particles, a droplet generator connected with the supply vessel, equipped with a multitude of jets generating extremely fine dispersion droplets of defined droplet size and a radiation device for irradiating the dispersion droplets produced by the droplet generator with electromagnetic waves or electrons.

Here again, the relevant features which result from this doctrine largely correspond to those which were earlier explained in connection with Variation A. A person skilled in the art will recognize which characteristics or measures are impossible to realize here.

If the dispersion is applied on the surface in the form of isolated droplets and if oligomers are already employed for producing the droplets according to the teaching of the invention, then attention needs to be paid that (with increased temperature) the polymerization degree will not be too high. Too high a polymerization degree produces too high a viscosity within the produced droplets, which has a detrimental influence upon the droplet size and thus also upon the size of the toner particles and also upon their shape. High viscosity occasionally produces the result that the toner particles do not present the desirable spherical shape.

According to another aspect, the invention relates to a system for the production of toner powder wherein the individual toner particles of the toner powder are formed by pigments incorporated in at least one polymer. The invention-specific system presents for said purpose a supply vessel for a dispersion of colorants, in particular pigments, in a liquid phase based on monomers and/or oligomers, which serve as starter substances for the polymer of the toner particles; a surface onto which the dispersion can be applied for hardening; means for applying the dispersion onto the surface, which are connected with the supply vessel and means for removal of the hardened dispersion from the surface. Such system facilitates a particularly efficient and cost-effective implementation of the invention-specific method.

These and additional objects, benefits and characteristics of the invention according to Variation B become obvious from the following detailed description of a preferred exemplary embodiment of the invention in connection with the Figures.

In the following, the invention is described in detail according to Variation B making reference to the appended Figures.

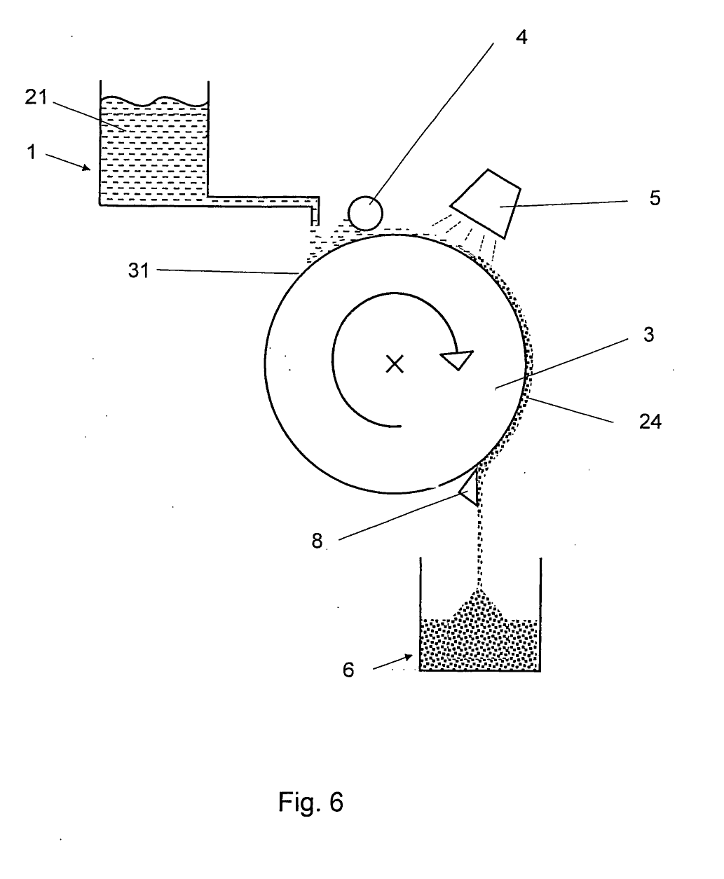

FIG. 6 depicts an invention-specific system for implementation of the invention-specific method.

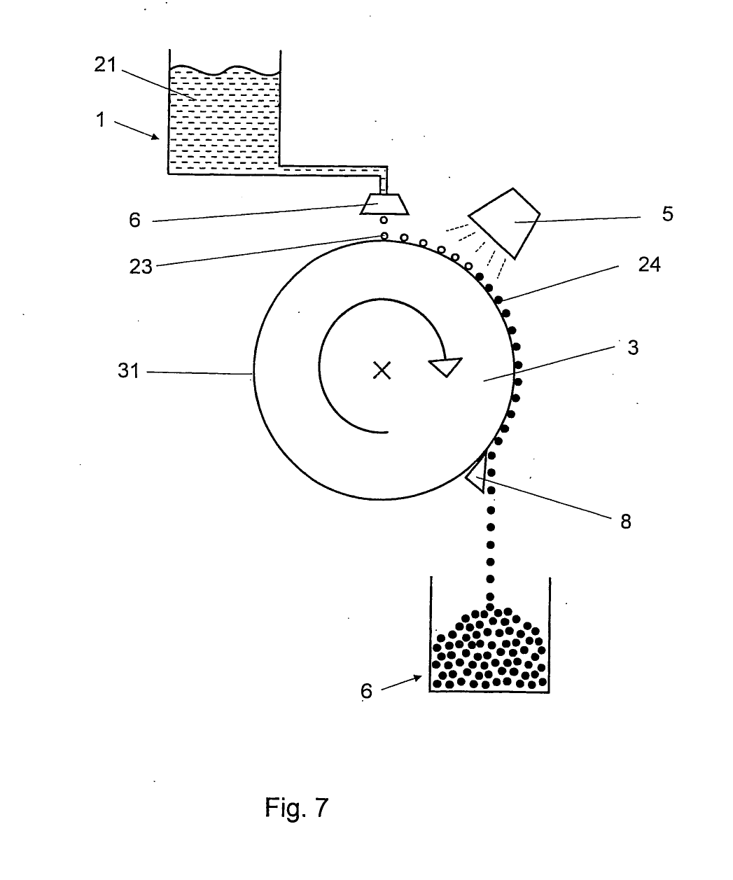

FIG. 7 depicts a preferred specific embodiment of the invention-specific system.

The reference symbols used in the drawing and their meaning are listed in the reference symbol listing. In principle, identical parts are given identical reference symbols.

FIG. 6 depicts an invention-specific system for the implementation of the invention-specific method.

A supply vessel 1 contains a dispersion composed of starter materials for the manufacture of toner particles, namely of monomers and/or oligomers in liquid phase, pigments and, perhaps, solvents, additional color substances, surface-active additives, load-control agents and similar substances. In order to achieve a highly uniform thorough mixing of the developing dispersion, the monomers and/or oligomers, pigments and additional components were mixed together in a mixing device which is not shown.

Near the bottom of the supply vessel 1 is a connection provided for a line system by means of which the dispersion 21 is applied to a surface 31 of a rotating drum 3. With a radially vis-a-vis the drum adjustable roller 4, the thickness of the applied dispersion layer can be adjusted to the desired value.

An energy supply device serves to supply the dispersion layer with energy. This may involve, for example, a hot air blower or an optical heating unit, which supplies energy in form of electromagnetic waves. If the dispersion contains a solvent, it is appropriate if the energy supply device 5 can supply the energy mainly in the form of heat. If the dispersion 21 contains such monomers and/or oligomers concerning which a polymerization reaction can be triggered via radiation, then an energy supply device 5 is preferably used, which can provide energy mainly in form of electromagnetic waves, in particular in the UV range.

The rotation speed of the drum 3 and the heating device 5 are preferably so attuned to each other and to the polymerization behavior of the dispersion 21 that the dispersion layer has become fully hardened after passing one of the areas covered by the heating device 5.

A scraper 4 finally scrapes the hardened dispersion layer from the surface 31. Broken pieces resulting from the scraping are collected in a receptacle 6. After that, the broken pieces are ground down in a grinding unit which is not shown.

FIG. 7 depicts a preferred specific embodiment of the invention-specific system. In this specific embodiment an inkjet print head 6 is provided for spraying the dispersion 21 in form of isolated droplets 23 onto the surface 31 of drum 3. By appropriate control of the ink-jet print head 5 it is thus possible to directly produce toner particles in the desired size. The need for a grinding process is thereby eliminated. In all other respects the system functions the same as the above described system according to FIG. 6.

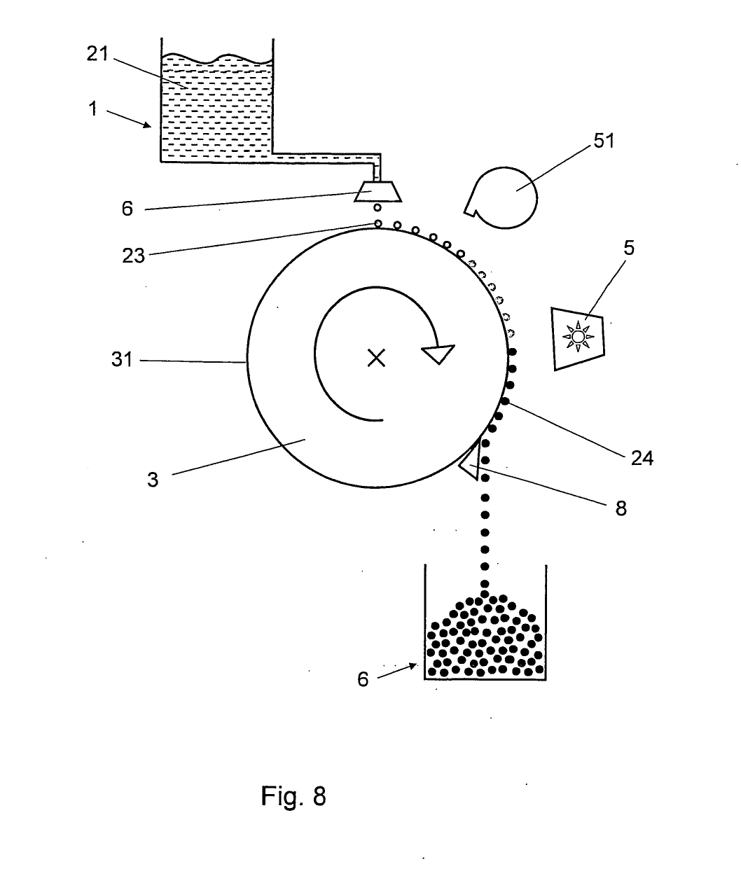

FIG. 8 depicts another preferred specific embodiment of the invention-specific system. In this embodiment, the supply of energy is provided by means of a combination of a hot air blower unit 51 and a UV lamp 52. This specific embodiment is particularly advantageous when toner powder is to be produced from a dispersion 23 which contains a solvent as well as monomers and/or oligomers, in which a polymerization reaction can be triggered by means of radiation.

In all of the described specific embodiments it is possible to beneficially utilize instead of a rotating drum 3, a conveyor belt, on the surface of which the dispersion 21 is applied. The surface of the drum 3 or the conveyor belt can also beneficially be heated from the inside, either instead of or in addition to energy supply via the heating device 5. The surface is preferably made in such fashion that the hardened dispersion adheres only very little so same. As a result, the hardened dispersion can more easily be scraped off or it detaches itself from the surface under the effect of gravity, or it can also beneficially be removed by suction. An appropriate surface can beneficially be established by coating the drum 3 or the conveyor belt for example with Teflon or silicon.

Listing of Reference Symbols for Variation A According to the Invention:

| | |
|---|---|
| 10 | System |
| 12 | Toner Particle |
| 14 | Mixing device supply vessel |
| 16 | Dispersion |
| 18 | Stirring Device Outlet |
| 20 | Outlet line |
| 22 | Inkjet Print Head |
| 25 | Jet Body |
| 26 | Jet Canals |
| 30 | Jet Apertures |
| 32 | Electrodes |
| 34 | Walls |
| 36 | Dispersion Droplets |
| 38 | Conveyor Belt |
| 40 | Radiation Device |
| 42 | Collection Device |
| 44 | Collection Container |
| T | Transport Direction |

Listing of Reference Symbols for Variation B According to the Invention:

| | | | |
|---|---|---|---|
| 1 | Supply Vessel | 51 | Hot Air Blower |
| 21, 22 | Dispersion | 52 | UV Lamp |
| 3 | Drum | 6 | Receptor Vessel |
| 31 | Surface | 7 | Ink Vapor Print Head |
| 4 | Roller | 8 | Scraper |
| 5 | Energy Supply Device | | |

1. Method for the manufacture of toner powder, wherein the individual toner particles (12) of the toner powder contain colorants incorporated into at least one polymer, in particular pigments, characterized in that as starter material of the polymer a liquid phase is provided based on a monomer and/or oligomer, the pigments are dispersed in said liquid phase, from the dispersion are produced extremely fine droplets (36) having a predetermined droplet size, and in the individual droplets (36) a polymerization reaction of the monomers and/or oligomers for formation of the polymer is caused by radiation of the droplets (36) with electro-magnetic waves or electrons, whereby the polymerized droplets (36) form the toner particles (12) of the toner powder.

2. Method according to claim 1, characterized in that as starter material for the polymer monomers or oligomers are used based on acrylate, methacrylate and/or styrene, or on basis of polyester forming monomers and/or oligomers.

3. Method according to claim 1, characterized in that load control agents are added to the fluid phase.

4. Method according to claim 1, characterized in that surface-active additives, waxes and/or magnetite are added to the fluid phase.

5. Method according to claim 1, characterized in that color substances are added to the fluid phase.

6. Method according to claim 1, characterized in that the droplets (36) are expelled through jets (30) which according to the principle of an ink-jet, in particular with the aid of piezo-electrical converters (26, 32) or thermo-electrical converters, produce droplets (36) having a defined droplet size.

7. Method according to claim 6, characterized in that a piezo-ink-jet print head (22) is used to generate the droplets (36).

8. Method according to claim 6, characterized in that the droplet size of the droplets (36) is controlled by modulation of the energy supply of the piezo-electrical converters (26, 32) or of the thermo-electrical converters.

9. Method according to claim 6, characterized in that the droplet expulsion per second and per jet (30) is adjusted to a range of 1 000 to 50 000 Hz.

10. Method according to claim 1, characterized in that the droplets (36) are irradiated with UV-rays or with electron rays in order to cause the polymerization reaction in the droplets (36).

11. Method according to claim 1, characterized in that the droplets (36) are charged electrostatically in order to prevent agglomerations.

12. Method according to claim 11, characterized in that the electro-static charge during generation of the droplets (36) or immediately following generation of the droplets (36) is caused by establishment of an electrical field.

13. Method according to claim 1, characterized in that the droplets (36), the partially hardened toner particles or the firm toner particles (12) are directed to a conveyor belt (38), moving at high speed, on which the polymerization reaction takes place, continues or is completed.

14. Method according to claim 13, characterized in that the droplets (36) adhering to the conveyor belt (28) are irradiated with electro-magnetic waves.

15. Method according to claim 13, characterized in that the conveyor belt (28), in case of electro-statically charged droplets (36) is charged with the opposite polarity vis-a-vis these droplet (36).

16. Method according to claim 1, characterized in that the dispersion droplets (36) are hardened during their flight.

17. Method according to claim 1, characterized in that the dispersion droplets (36) exiting from the droplet generator are put into a state of suspension and are hardened in said state of suspension.

18. Method according to claim 1, characterized in that the droplet size is adjusted in such manner that the particle size of the obtained toner particles (12) lies between approximately 2 and 9 μm, in particular between approximately 4 and 7 μm.

19. Method according to claim 1, characterized in that the liquid phase of the droplets produced prior to treatment with rays is adjusted to a viscosity of approximately 1 to 50 mPas, in particular of approximately 1 to 15 mPas.

20. System for the manufacture of toner powder, wherein the individual toner particles of the toner powder contain pigments incorporated in at least one polymer, characterized by a supply vessel for a dispersion of pigments in a liquid phase based on monomers and/or oligomers, which serve as starter materials for the polymer of the toner particles, a droplet generator (22) connected with the supply vessel (14) equipped with a multitude of jets (30) for generating extremely fine dispersion droplets (36) having a defined droplet size and a radiation device (40) for radiation of the dispersion droplets (36) generated by the droplet generator (22) with electro-magnetic waves or electrons.

21. System according to claim 20, characterized in that the radiation device (40) irradiates the droplets (36) with UV-rays or electron rays.

22. System according to claim 20, characterized in that each jet (30) of the droplet generator (22) is assigned a piezo-electrical or thermo-electrical converter (26, 32) and that the converters (26, 32) of the jets (30) are at least group-wise combined and connected with an electrical control for operation of the converters (26, 32).

23. System according to claim 22, characterized in that the droplet generator is a conventional ink-jet-print head (22).

24. System according to claim 20, characterized by a mixing device connected with supply vessel (14) for dispersing the pigments in the liquid phase based on monomers and/or oligomers.

25. System according to claim 20, characterized in that the droplet generator (22) sprays the droplets (36) onto a conveyor belt (38) moving at high speed past the jets (30).

26. System according to claim 25, characterized in that the radiation device (40) is arranged along side the transport path of the conveyor belt (38) and irradiates the dispersion droplets (36) resting on the conveyor belt with electromagnetic waves.

27. System according to claim 20, characterized in that the radiation device (40) is arranged immediately behind the droplet generator (22) in order to irradiate the generated dispersion droplets (36) in flight or in a state of suspense.

28. System according to claim 20, characterized in that the droplet generator expels the droplets in a closed radiation space into which the radiation device emits rays.

29. Toner powder with toner particles, obtainable according to a method in accordance with claim 1.

30. Method for the production of toner powder, whose individual toner particles contain at least one colorant incorporated in a polymer, in particular pigments, which comprises the following steps:
as starter material is provided for the polymer a liquid phase based on at least one monomer and/or oligomer,
at least the one colorant is dispersed in the fluid phase, the dispersion is applied to a surface, the dispersion is hardened on the surface by means of the at least one monomer and/or oligomer and subsequently removed from the surface.

31. Method according to claim 1, characterized in that the liquid phase contains at least one solvent which is at least partially evaporated during hardening.

32. Method according to claim 1, characterized in that an application thickness of the dispersion is selected having the size of a particle diameter of the toner powder to be produced, whereby in particular the application thickness is smaller than twice the particle diameter.

33. Method according to claim 31, characterized in that the dispersion in essence is applied over the entire surface and after removal from the surface, comminution takes place, in particular by means of grinding.

34. Method according to claim 30, characterized in that the dispersion is applied, in essence, on the surface in the form of isolated droplets whereby an average droplet diameter is selected having the size of a particle diameter of the toner powder to be produced, in particular smaller than twice the particle diameter.

35. Method according to claim 30, characterized in that the isolated droplets are expelled by jets which function according to the principle of an inkjet print head, based in particular on piezo- or thermo-electrical converters.

36. Method according to claim 30, characterized in that the dispersion is hardened under addition of energy, in particular under the effect of radiation.

37. System for the production of toner powder, wherein the individual toner particles of the toner powder contain colorants incorporated into at least one polymer, in particular pigments, comprising a supply vessel (14) for a dispersion (21,22) of colorants, in particular pigments, in a fluid phase based on monomers and/or oligomers, which serve as starter materials for the polymer of the toner particles, a surface (31) onto which the dispersion (21,22) can be applied for hardening by means of polymerization, means (61, 62) connected with the supply vessel (1) for applying the dispersion (21, 22) onto the surface (31) and means (8) for removal of hardened dispersion (23, 24) from the surface (31).

38. System according to claim 37, characterized by means (5, 51, 51) for acceleration of the hardening.

39. System according to claim 37, characterized in that the means for application of the dispersion onto the surface comprise a multitude of jets generating extremely fine droplets, in particular having a predetermined drop size.

40. Toner powder with toner particles, obtainable according to a method according to claim 30.
